(19) United States
(12) Patent Application Publication
(10) Pub. No.: US 2011/0049024 A1
(43) Pub. Date: Mar. 3, 2011

(54) METHOD FOR TREATING RUNOFF WATER USING A SERIES OF TREATMENT SEQUENCES TO REMOVE FINE POLLUTANTS AND CLAY

(76) Inventor: Thomas Pank, Walkersville, MD (US)

(21) Appl. No.: 12/868,374

(22) Filed: Aug. 25, 2010

Related U.S. Application Data
(60) Provisional application No. 61/238,675, filed on Aug. 31, 2009.

(51) Int. Cl. E03F 1/00; B01D 35/00; C02F 1/00; E03F 5/00

(52) U.S. Cl. 210/104; 210/97

(57) ABSTRACT

A treatment system for removal of contaminates includes the introduction of a flocking agent and the settling of resultant aggregations of particulate material, followed by filtration of the remaining water to remove residual flocking agent and particulate matter. Water thus treated is sufficiently clean to discharge into downstream receiving waters, in an effective and efficient manner, and is sufficiently free of flocking agent to avoid being a hazard to aquatic life. The required dose is activated by a rain gauge which meters rainfall over an appropriate time period and evaluated by the microprocessor.

### REFERENCE TO RELATED CASES

This application claims the benefits of U.S. Provisional application Ser. No. 61/238,675, filed Aug. 31, 2009.

### BACKGROUND OF THE INVENTION

When it rains on a construction site with exposed soil, rain water can cause the soil to erode and be carried into receiving waters, contaminating them with sediment loads and rapidly deteriorating them.

Heavy contaminates and light oils can be separated from a fluid stream by drawing from the center of a fluid stream. Fine, suspended particles are the most difficult sediment particles to remove, because they require very long settling times and low turbulence in the fluid stream to settle out. It is also most often these fine particles (mainly clay particles) that contribute the most to turbidity (increased opacity) in the water.

There are a number of methods and technologies used to remove sediments prior to discharge with varying degrees of efficacy. One method of expediting the removal of these fine suspended contaminants is with the introduction of flocculation agent(s) which are used to cause the fine particles to coagulate and settle more quickly. Most of these have an ionic charge which is opposite that of the particles to be settled. As the sediment particles attach to the flocculation agent particles the aggregate particles become larger and larger and settle more quickly. The disadvantage associated with the use of flocculation agents is that in some cases they may involve the addition of something that may be considered a pollutant, and for waters with fish in them, higher concentrations of flocculation agent can cause an occlusion of the fish gills as the gills function with a charge opposite of the flocculation agent causing the agent to accumulate on the gills which could suffocate the fish and kill them.

While fish are typically not a concern within sediment basins (ponds) at a construction site, where the flocculation agent is introduced and the fine particles are aggregated and settled out of the rain water runoff, fish are a concern in down stream receiving waters. Therefore, it is important to introduce a proper amount of flocculation agent into the rainwater runoff stream, sufficient to remove fine suspended sediment without excess. For example, a minimum of 0.5 ppm of flocculation agent may be sufficient to remove the sediment particles in a particular rainwater runoff, and a dose above 15 ppm may be toxic to some fish species. Therefore it is critical that the proper amount of flocculation agent be introduced into the rainwater runoff to be certain that there is no chance of the floc being overdosed and discharged into the downstream receiving waters.

One method utilized to avoid the use of excess flocking agents uses a highly controlled, pump and metering system to carefully meter the water and dose the flocculation agent. The water is then retained in a settling tank for a sufficient period of time to allow the settling of the fine sediments to settle. The water is tested for the presence of residual flocking agent and then discharged into the receiving body of water only if the residual presence of flocking agents is below a minimal value. This, although safe and effective, is very expensive.

Flocking agents can also be administered by placing the flocking agent into a cloth or semi-porous material sock. This sock is then placed into a gravity flow pipe or pump discharge pipe and, as the water flows through the sock, the flocking agent is slowly released. This is a very crude and risky means of inducing the flocking into the water stream, because dosing rates are virtually impossible to control with any level of precision and an overdose could easily occur.

### SUMMARY OF THE INVENTION

This invention treats runoff water which is laden with fine particulate sediment prior to discharge into downstream waters. The invention incorporates a treatment train with a dosing system for introducing a flocking agent and a settling means to allow settling of resultant aggregations of particulate material, followed by filtration of the remaining water through a filter to remove any residual flocking agent as well as particulate matter. Water thus treated is sufficiently clean to discharge into downstream receiving waters, in an effective and efficient manner, and is sufficiently free of flocking agent to avoid being a hazard to aquatic life.

A series of components are utilized in a treatment train that will clean runoff water. First the required dose is activated by a rain gauge located on a dosing station near the inlet of the sedimentation pond. As the rain occurs, the rain gauge meters the amount of rainfall and sends that data to a microprocessor. The microprocessor will get a signal for each interval of rain (typically 0.01″). The microprocessor can then determine the dose by taking into consideration any number of parameters: antecedent dry period from last rain event, minimum rainfall before dosing will occur, site conditions that will contribute to the runoff, intensity of the rainfall (interval between signals of at least 0.01″), drainage area to the system, time of year, temperature, time to concentration of the runoff, soil types, effluent targets, and target dose concentration. This data will then be evaluated by the microprocessor to determine the precise amount of floc agent to be dispersed. The dosing station is preferably one that uses a finely ground powdered floc agent such as chitosan, metered using an auger with controlled rotation, however any number of feed metering methods may be employed including for example feeding a liquid floc agent by metering with a peristaltic pump. The preferred method of dosing the floc agent is at or near the inlet of the sediment basin so the floc mixes with the turbid influent. As the turbid runoff water enters the pond, mixed with the floc agent, flocculation and subsequent settlement will occur.

When the pond reaches a certain level, water is skimmed from the storage chamber and diverted by gravity or pump to a filtration vault. The filtration vault will have filters preferably of a polypropylene felt that will remove any unsettled and/or floc'd particles as well as residual floc.

This system controls the dose of floc agent to a level that the risk of overdosing is minimized, and by the filtration method incorporated any residual floc is removed prior to discharge. The present invention achieves an efficient means for cleaning very fine (typically clay) particles from runoff water, typically the reduction of the clay content of the water to a negligible level. The present invention is capable of removal of 99% of the clay particles in a stream of water with less than 10 minutes of residence time in the filter vault.

### BRIEF DESCRIPTION OF THE DRAWINGS

FIG. 1 is a diagram of the overall system for capture and treatment of runoff from a job site.

FIG. 2 is a detail diagram of the rain gauge controlled floc agent dosing station.

FIG. 3 Shows the system with the filtration vault located within the sedimentation basin

FIG. 4 shows the system with the filtration vault located Outside of the sedimentation basin (opposite a weir wall).

FIG. 5 shows the system utilizing a lift pump to pump the water to the filtration vault located outside of the sedimentation basin.

FIG. 6 shows the siphon feature associated with the skimmer and filter vault.

### DETAILED DESCRIPTION OF PREFERRED EMBODIMENTS

An exemplary embodiment of the present invention is illustrated as implemented on a construction job site, which can typically introduce a large quantity of fine particulate sediment into the rainwater runoff water. Although the present invention is illustrated in connection with a construction site, the invention is applicable in any situation where fine particulate material is introduced into a water flow and requires removal, whether or not the introduction of the material is the result of soil erosion.

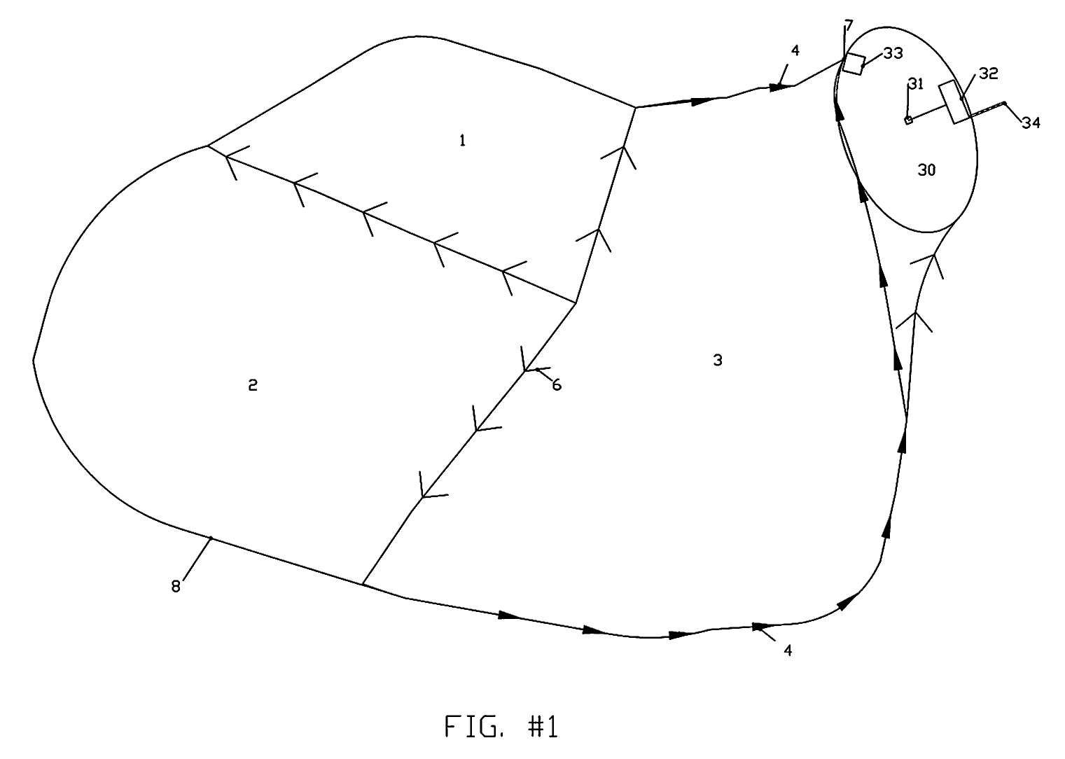

Prior to start of construction the job site FIG. 1 topography is analyzed to determine the water runoff flow for the limits of the construction site 8. The analysis will determine how rain water and/or ground water drains from the site. Typically a site is divided into drainage areas, such as drainage areas 1, 2 and 3 illustrated in FIG. 1, which are separated by drainage divides 6. An analysis is also made to determine the surface area in a particular drainage area to determine the volume of rain that will fall on that area for each increment of rainfall. As an example, a sedimentation basin 30 will be constructed at the low point of the drainage area 3. The drainage divides 6 and diversion berms 4 will divert all runoff water to an influent location 7 of sedimentation basin 30. At preferably the most concentrated inlet location 7 to the sedimentation basin 30, is a floc dosing station 33. Inside of the sedimentation basin 30 is a floating skimmer 31, a filter vault 32, and an effluent pipe 34. Ideally the sedimentation basin may contain a high flow bypass means (not shown) to safely convey extreme storms beyond the flow capacity of the filter vault.

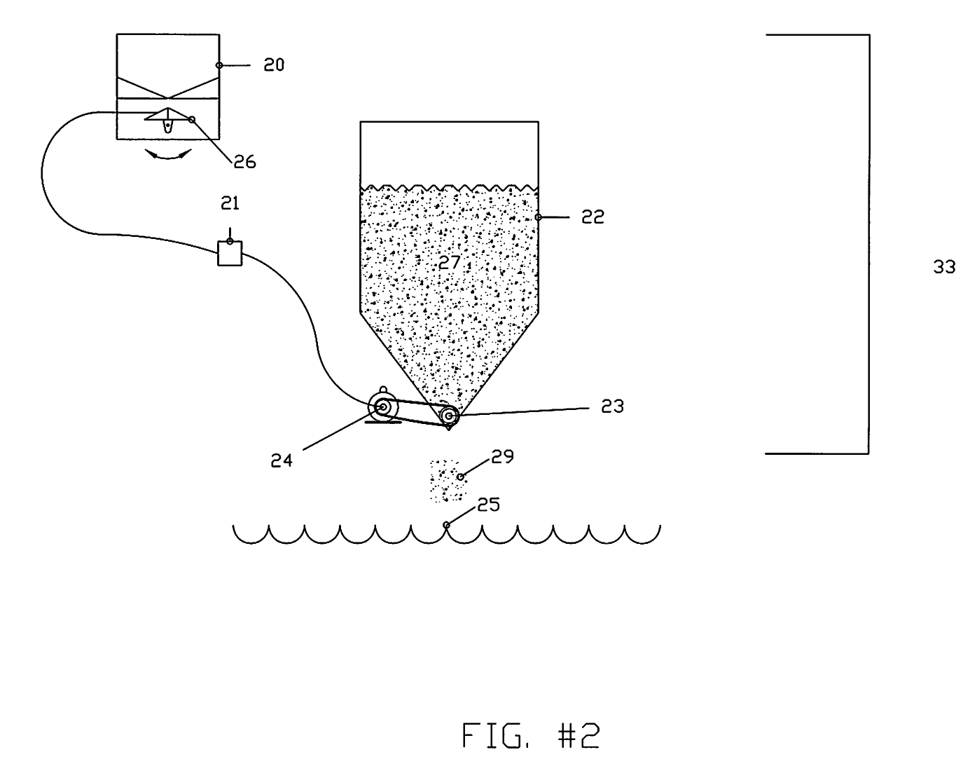

FIG. 2 shows the core components of the dosing station 33. This is typically a self contained modular unit which is capable of operating remotely with a battery and solar operated battery charger. The dosing station 33 has a rain metering means (rain gauge) 20. Each increment of rain (typically at least 0.01″) sends a signal to a microprocessor 21, which collects this data. The microprocessor will have any number of variables programmed into it which, combined with each increment of rain data, will be used to determine the appropriate volume of floc agent to disperse. The microprocessor will then use programmed variables such as expected runoff for the geographic conditions, rainfall intensity (interval between increments), drainage area, dry period from last storm event, target effluent concentrations, time of year, temperature, and other variables determined to target the best dosage.

The quantity of flocking agent dosed into the water can be dependant on the quantity of rain as a one dimensional variable or can also include the rate of rainfall over time as a second dimension variable to adjust the dosage of flocking agent. For example the same total quantity of rain falling over a shorter period of time may require a greater quantity of flocking agent than the same total quantity of rain falling over a longer period of time. Also, the same periodic quantity of rainfall with greater or less separation between periods of rainfall may require differentiated treatment dosages. With the incremental rainfall data, the microprocessor then determines the timing and volume of floc agent to disperse. This can be done using either a standard dose of for example 1 gram and sending a signal to dose 1 gram at a time or it can be done by determining the exact amount and controlling the rotation of the auger to meter that precise amount. There are many means of taking this computed data and metering the appropriate dose, including for example using a liquid floc agent and a peristaltic pump to meter the volume. In the preferred example provided, the rain gauge 20 located on the dosing station 33 trips a tipping bucket 26 for each increment of rain. This sends a signal to the microprocessor 21 which uses that signal to process, in conjunction with the other variables, and determines the appropriate dose of floc agent 29 to disperse into the influent water 25. The microprocessor 21 having computed the volume of floc agent 27 and time to disperse, converts this volume to degrees of rotation of the dosing auger 23 and sends a signal to the motor 24 to rotate the dosing auger 23 by that amount thereby sending the precise dose of floc 29 into the influent stream 25.

Locating the dosing station at the most turbid input location is ideal in that it will enable the greatest mixing of the floc agent and the influent stream. The flocked water then enters the sedimentation basin 30 and begins to settle the fine solids and flocked clay particles. As the water level rises in the sedimentation basin 30, it will raise to the point that the skimmer 31 will begin to flow water into the filter vault 32. The water that flows into the filter vault 32 has been skimmed from just below the surface so that it has had the maximum settling time and is the cleanest. This water will still contain some solids and floc. The water enters the filter vault 32 and flows through the filters 38 which remove the remaining turbidity causing contaminants, any remaining flocked solids, as well as the residual floc agent. From there the water is released through the effluent pipe 34 to the downstream receiving waters.

The filters 38 are preferably polypropylene felt and of a spiral wrapped design, to optimize surface area. However the filters can be of many different combinations including sand, fabrics or other media.

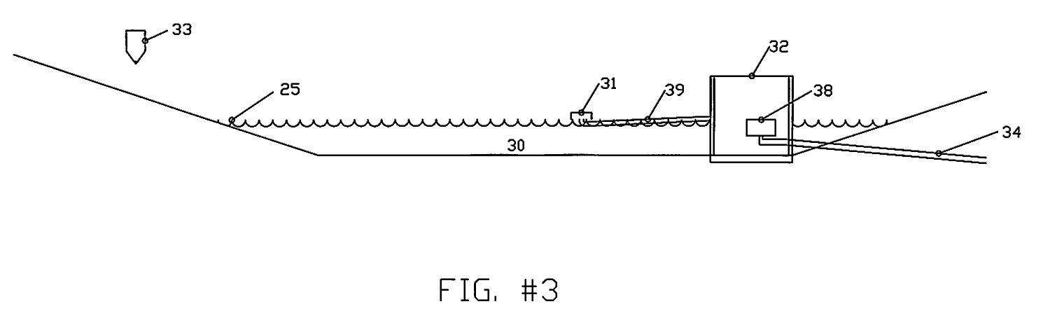

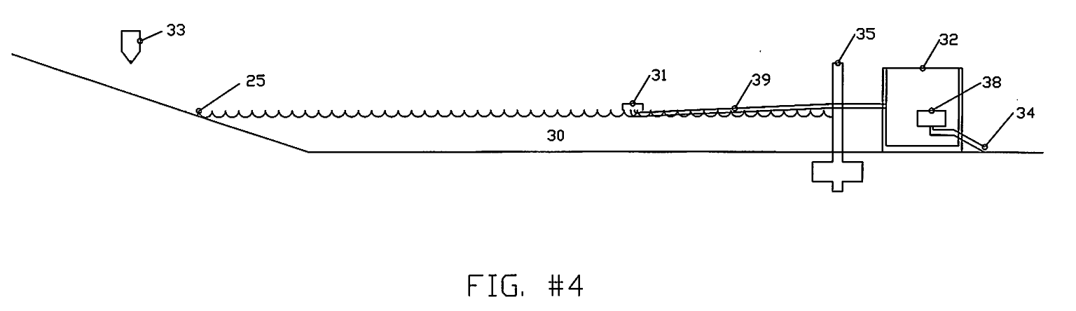

FIGS. 3, 4, and 5 illustrate alternative locations of the filtration vault 32 relative to the sedimentation basin 30. FIG. 3 shows the filtration vault 32 inside of sedimentation basin 30. FIG. 4 shows the filtration vault 32 is located outside of the sedimentation basin 30, just opposite of a weir wall 35. The weir wall 35 could also be simply an embankment.

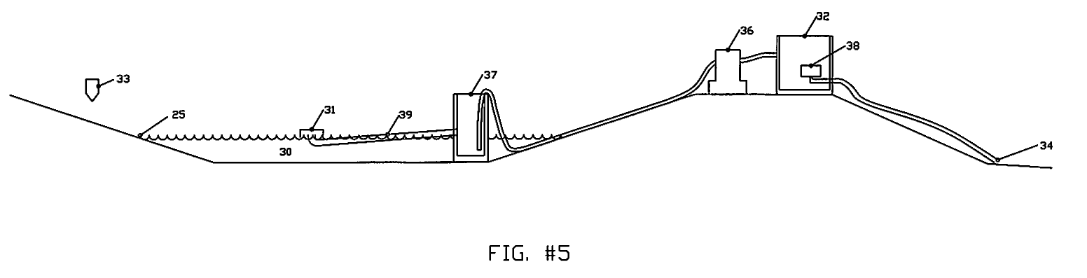

FIG. 5 illustrates the filtration vault 32 located outside of the sedimentation basin 30, at a height which prevents the water from flowing into the filtration vault 32 by gravity. When the filtration vault 32 is located above the level of the water in the sedimentation basin, water can be pumped directly from the skimmer pipe 39 or alternatively, a sump basin 37 can be located within the sedimentation basin 30 and the skimmer pipe 39 can discharge into the sump basin 30. As the water enters the sump pump basin 37 it is pumped by a lift pump 36 to the filtration vault 32.

The present invention enables a calculated and precise dose of floc agent, followed by sedimentation, and then a final filtration step which removes remaining sediments, remaining partially flocked clays, as well as residual floc agent. Thereby insuring that only clean water free of any floc agent is discharged into receiving waters.

A system designed to implement the present invention can be altered or optimized to address the particular needs, requirements and/or design choices and considerations of the particular installation. For example, increasing the settling time will reduce the load on the filter and increase its life expectancy. Decreasing the settling time will allow a smaller pond to process a greater quantity of rainwater in a given amount of time but will decrease the useful life of the filters because they will be able to process a smaller quantity of water before replacement.

In another exemplary embodiment, a second skimmer 31 is added to the filtration vault 32 which operates only when the sedimentation basin 30 reaches a certain increased level. This will decrease the load on the filters during most storms yet be able to still treat the higher volume/intensity storms, thereby optimizing the filter life between change outs.

In further exemplary embodiment, a float controlled metering valve can be installed on the filter effluent pipe 34, inside the filtration vault 32, which is float activated thereby increasing the flow of the filters at higher levels of water in the filtration vault.

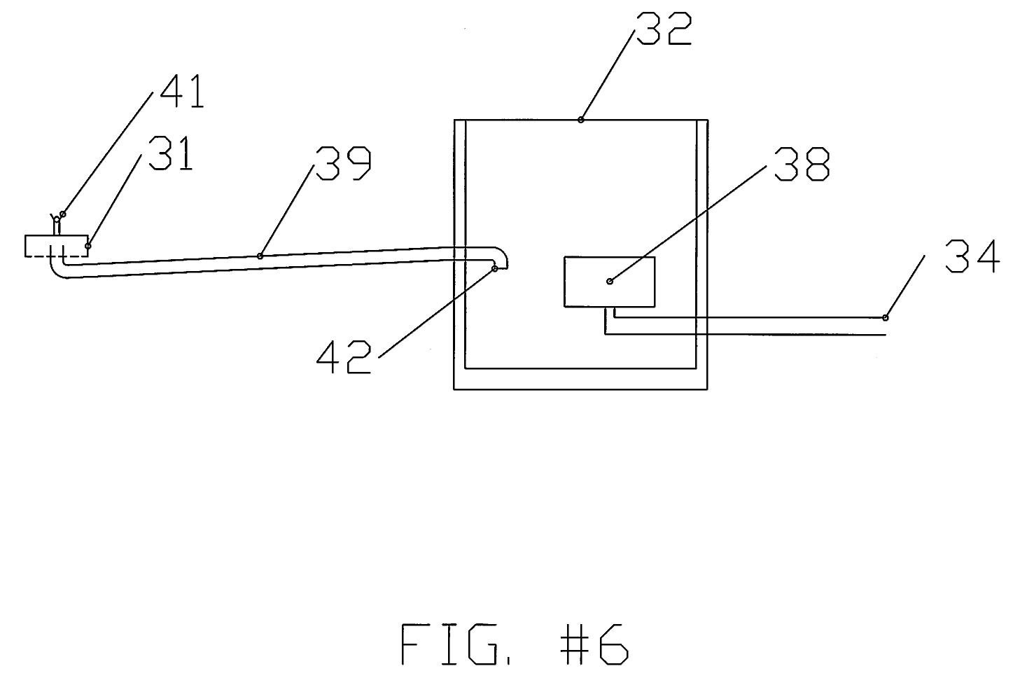

In an additional exemplary embodiment, FIG. 6, shows the floating skimmer 31 adapted with a one way air release valve 41. As the water level rises in the sedimentation basin 30, it will displace the air under the hood of the skimmer 31 through the air release valve 41. The water will flow through the skimmer pipe 39 into the filtration vault 32. There is a turned down elbow 42 located on the skimmer pipe 39 inside of the filtration vault 32. Once the water has achieved an elevation above the top of the skimmer pipe 39 where it enters the filtration vault 32 there will be a sealed (air free) water chamber. Then as the storm event subsides, a siphon occurs until the water level in the filtration vault is below the bottom of the elbow 42 and at that point air will enter and break the siphon. This achieves an increased settling time and capacity between storm events, further reducing load on the filters and further increasing their life cycle.

Treatment train above

I claim:

1. A water treatment apparatus, comprising:
a rain gauge for measuring rainfall,
a processor for receiving rainfall measurements from said rain gauge and for analyzing said rainfall measurements according to predetermined parameters for determination of dosing treatment, and
a flocculation dispenser operatively connected to and controlled by said processor to dispense flocculation agent into a body of runoff water dependant upon said analysis of said rain fall measurements by said processor.

2. The water treatment apparatus of claim 1, further comprising:
a filter positioned downstream of said body of runoff water for filtering said runoff water after a period of settling subsequent to said dispensing of said flocculation agent.

3. The water treatment apparatus of claim 2, wherein said flocculation agent includes chitosan.

4. The water treatment apparatus of claim 3, wherein:
said filters include at least one polypropylene filtration layer.

5. The water treatment apparatus of claim 2, further comprising:
a filtration vault having an intake and a discharge, wherein said filter is positioned within said filtration vault between said intake and said discharge for filtering water flowing through said vault, and
a water skimmer having an intake below the water surface of said body of runoff water, and a discharge into said filtration vault intake.

6. The water treatment apparatus of claim 5, further comprising:
a float controlled metering valve controlling said vault discharge to increase the water flow through said filter in response to increased water levels within said filtration vault.

7. The water treatment apparatus of claim 5, wherein:
said filtration vault is located within said body of runoff water.

8. The water treatment apparatus of claim 5, wherein:
said filtration vault is separated from said body of runoff water by a weir wall or embankment.

9. The water treatment apparatus of claim 5, wherein:
said filtration vault is located at an elevation above said body of runoff water, and further comprising:
a sump basin located within said body of runoff water, and
a lift pump having an intake and a discharge, wherein:
said skimmer discharge is connected to and discharges into said sump basin
said lift pump pumps water from said sump basin into said filtration vault intake.

10. The water treatment apparatus of claim 5, wherein said water skimmer further includes:
a inverted cover operatively connected to said subsurface intake, and having an air release valve connected to release air from within said inverted cover as the water level rises in said body of runoff water,
a downward facing outlet section at said discharge of said skimmer within said vault.

11. The water treatment apparatus of claim 5, wherein:
said intake of said water skimmer is fixed at a first predetermined level within said body of runoff water to skim water when said level of said water within said body of runoff water exceeds said first predetermined level, and further comprising:
a second water skimmer having an intake positioned at a second predetermined level above said first predetermined level for providing a secondary flow of water to said vault during increased rates of runoff flow.

12. The water treatment apparatus of claim 1, wherein:
said processor determine the quantity of flocculation agent dispensed, based upon one or more of the following parameters: antecedent dry period from last rain event, minimum rainfall, site conditions that contribute to runoff, intensity of the rainfall, rate of rainfall, drainage area, time of year, temperature, soil conditions, effluent targets, and target dose concentration, settling time in said body of runoff water.
